(19) United States
(12) Patent Application Publication
(10) Pub. No.: US 2016/0264220 A1
(43) Pub. Date: Sep. 15, 2016

(54) BOAT LOADING SYSTEM

(71) Applicants: William P. Laceky, Georgetown, TX (US); Bruce A. Johnson, Austin, TX (US); Charles C. Hoover, Bull Shoals, AR (US); Thompson James Pooton, Henderson, NV (US)

(72) Inventors: William P. Laceky, Georgetown, TX (US); Bruce A. Johnson, Austin, TX (US); Charles C. Hoover, Bull Shoals, AR (US); Thompson James Pooton, Henderson, NV (US)

(21) Appl. No.: 15/001,189

(22) Filed: Jan. 19, 2016

Related U.S. Application Data
(60) Provisional application No. 62/104,855, filed on Jan. 19, 2015.

(51) Int. Cl. B63B 49/00; H04N 5/232; H04N 5/225; B60P 3/10

(52) U.S. Cl. CPC B63B 49/00; B60P 3/1075; H04N 5/23293; H04N 5/2256; B60Q 1/48

(57) ABSTRACT

A system and method is provided for assisting with the loading of a boat at a desired parking target, such as boat trailer or dock. In one example, a light source is provided on a boat trailer to illuminate the trailer. A forward facing camera and corresponding monitor are provided on a boat. As the boat approaches the boat trailer, the light source makes the boat trailer more visible, especially in low light conditions. The light source is also visible on the monitor, making it easier for a boat operator to guide the boat to the trailer.

### CROSS REFERENCE TO RELATED APPLICATIONS

This application is a claims priority to co-pending commonly owned U.S. Provisional patent application No. 62/104,855, attorney docket number LAC101, filed on Jan. 19, 2015, entitled “BOAT LOADING SYSTEM,” which is incorporated by reference herein.

### FIELD

This disclosure relates to boats and boat parking. In particular, this disclosure is drawn to a boat loading system for assisting with the guidance of a boat to a boat trailer or dock.

### BACKGROUND

Typically, when loading a boat from the water onto a boat trailer, the boat trailer is backed down a boat ramp into the water. The operator/driver of the boat then guides the boat onto the partially submerged trailer by aligning the boat with the trailer. This can be a challenging task, especially in low light conditions (e.g., at night, in fog, etc.). While boat trailers may have tail lights or illuminated guide posts, it may still be difficult to properly align the boat with the trailer during the loading process.

### SUMMARY

A boat loading system is provided including a light source coupled to a boat trailer, a camera coupled to a boat, a video screen operatively coupled to the camera for displaying video from the camera, and wherein the video screen and camera are configured to convey the relative position of the light source and the boat to assist a boat operator in guiding the boat to a desired position relative to the boat trailer.

Another embodiment provides a boat loading system including a light source configured to be installed on a boat trailer, a camera configured to be installed on a boat, a video screen configured to be installed on the boat and to be operatively coupled to the camera for displaying video from the camera, and wherein the video screen and camera are configured, when installed, to convey the relative position of the light source and the boat to assist a boat operator in guiding the boat to a desired position relative to the boat trailer when loading the boat on the boat trailer.

Another embodiment provides a method of parking a boat at a desired parking target including activating a light source on the parking target, guiding the boat toward the parking target based on based on the relative positions of the light source and the boat.

Other features and advantages of the present disclosure will be apparent from the accompanying drawings and from the detailed description that follows below.

### BRIEF DESCRIPTION OF THE DRAWINGS

The present disclosure is illustrated by way of example and not limitation in the figures of the accompanying drawings, in which like references indicate similar elements and in which:

FIG. 1 is an isometric view of a boat trailer according to one example of the present disclosure.

FIG. 2 is a rear isometric view of the boat trailer shown in FIG. 1.

FIG. 3 is a top view of the boat trailer shown in FIG. 1.

FIG. 4 is a partial view of a boat according to the present disclosure.

FIGS. 5-6 are views of a boat approaching a partially submerged boat trailer on a boat loading ramp, with the submerged portion of the boat trailer shown by dashed lines.

FIGS. 7A-7D are exemplary views of a control panel display as a boat approaches a boat trailer on a loading ramp.

FIGS. 8-11 are rear isometric views of a boat trailer illustrating various alternative light source configurations.

FIG. 12 is an exemplary view of a control panel display as a boat approaches a boat trailer on a loading ramp.

FIGS. 13-16 are block diagrams of exemplary boat loading system configurations.

FIG. 17 is a top view of a dock having an opening configured to receive a boat.

FIG. 18 is a top view of a dock having a boat lift.

FIG. 19 is a front view of a display with overlaid horizontal graphical lines.

### DESCRIPTION

Generally, the present disclosure relates to techniques for assisting with the loading of a boat onto a trailer. In one example, a light source is provided on the boat trailer to illuminate the trailer. A forward facing camera and corresponding monitor are provided on a boat. As the boat approaches the boat trailer, the light source makes the boat trailer more visible, especially in low light conditions. The light source is also visible on the monitor, making it easier for a boat operator to guide the boat to the trailer. The camera being mounted in the front of the boat provides an unencumbered view of the trailer on the monitor. The driver typically sits at the middle to rear end of the boat while driving, so without the camera, the driver's view of the trailer is increasingly blocked by the front deck of the boat as the boat draws closer to the trailer, making it difficult for the driver to gauge how well centered the boat is in relation to the trailer.

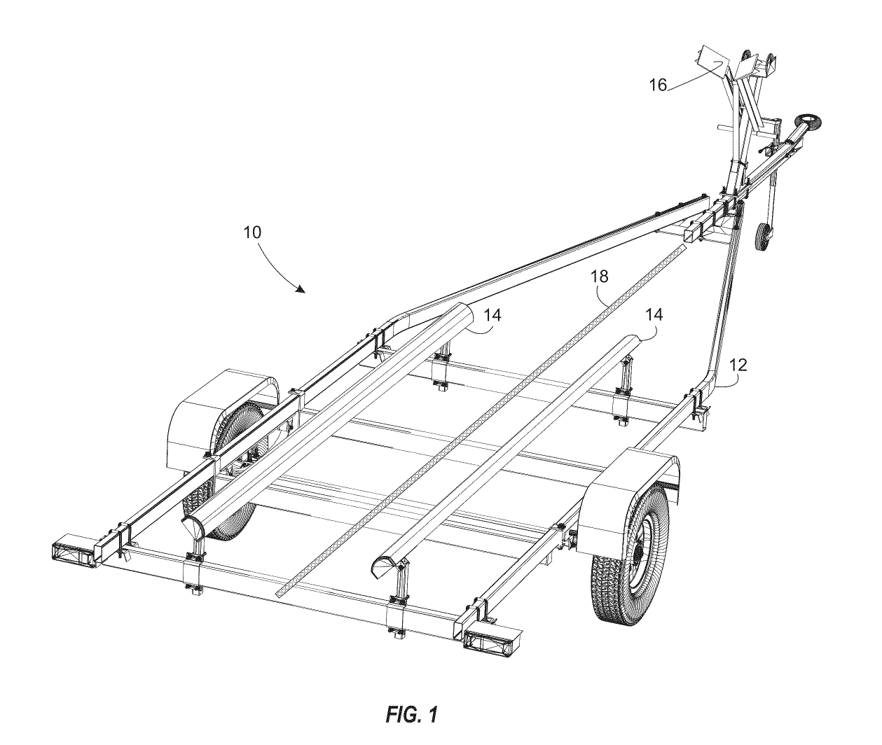

FIG. 1 is an isometric view of a boat trailer 10. The boat trailer 10 comprises a frame 12, to which wheels, bumpers, lights, a tongue, a winch post assembly, etc. are attached. The boat trailer 10 shows one example of a typical boat trailer configuration. Other configurations are also possible, such as multi-axis trailers, trailers with rollers instead of (or in addition to) rails, etc. A pair of opposing guide rails 14 are coupled to the frame 12 to guide and support the boat when loaded on the trailer 10. Near the front of the boat trailer, a pair of opposing winch post bumpers 16 are coupled to a winch post assembly.

In addition to conventional tail lights and running lights, the boat trailer 10 includes a light source 18 to help illuminate the trailer 10 during the loading process. In the example shown in FIG. 1, the light source 18 is an elongated strip of lights extending down the middle of the boat trailer 10 from the back of the trailer 10 to the tongue. As described below, other configurations of light source(s) are also possible. In one example, the light source 18 is a strip of bright LEDs. The LEDs may be comprised of a single color, selectable colors, solid, flashing, chasing, etc., as desired. The light source may also be made from incandescent lights, electroluminescent wire, fiber optics, etc. In addition, multiple light sources may be used. In the example of an LED strip, any type of LED strip may be used. In one example, the LED strip may be comprised of a strip of surface-mount-device (SMD) light-emitting diode (LED) modules using surface-mount technology to mount LED chips on a fixed or flexible printed circuit board (PCB). The Led strip may be encapsulated in epoxy (or other suitable material) to make the LED strip waterproof.

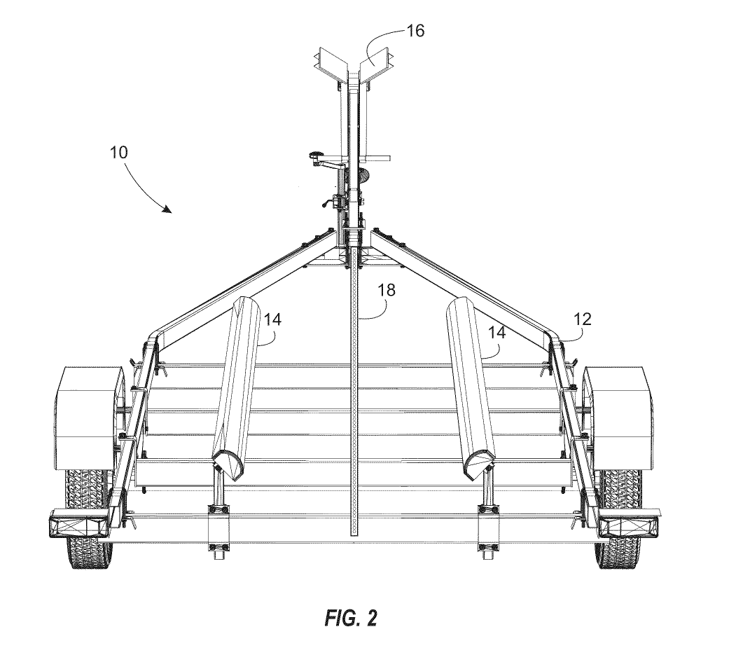

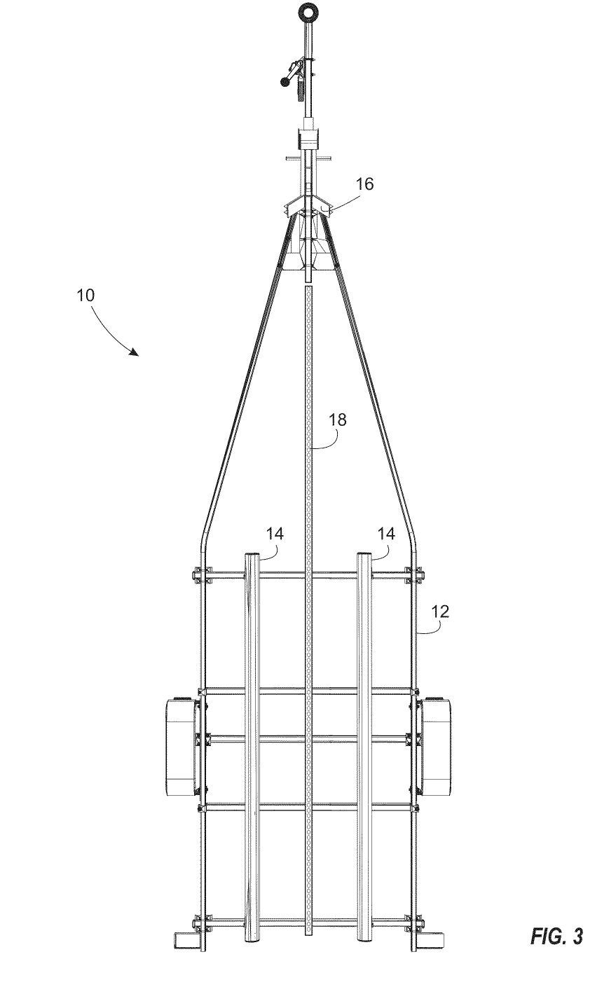

FIG. 2 is a rear isometric view of a boat trailer 10 shown in FIG. 1. FIG. 3 is a top view of the boat trailer 10 shown in FIGS. 1 and 2. FIGS. 2 and 3 also show opposing guide rails 14 coupled to the frame 12 of the boat trailer 10. The light source 18 is also coupled to the frame 12 and extends from the rear of the trailer 10 to near the front of the frame 12.

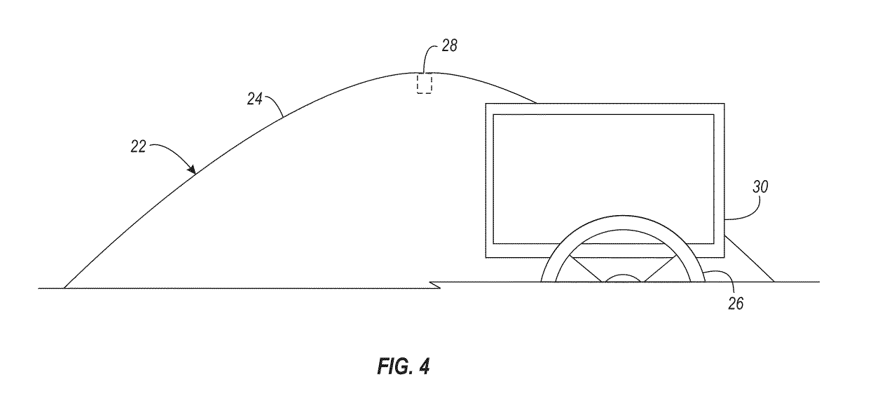

FIG. 4 is a partial view of a boat 22 according to one example of the present disclosure. As mentioned above, a boat loading system may include a forward facing camera and a corresponding display for displaying the output of the camera. FIG. 22 shows a boat 22 having a hull 24 and steering wheel 26 positioned at a dashboard. For clarity, various other components of the boat 22 are not shown. In this example, a camera 28 (shown by dashed lines) is mounted to the hull 24 and is pointed to the area in front of the boat. A video display 30 is mounted on the boat dashboard and is capable of displaying the output of the camera 28. The video display 30 may be a stand-alone display, or be part of a boat control system. In other examples, the video display 30 can be part of another system such as a fish finder, depth finder, distance finder, etc. the video display may also be a touch display, allowing various functions of the system (or other systems) to be controlled via touch controls. In other examples, information can be overlaid on the display.

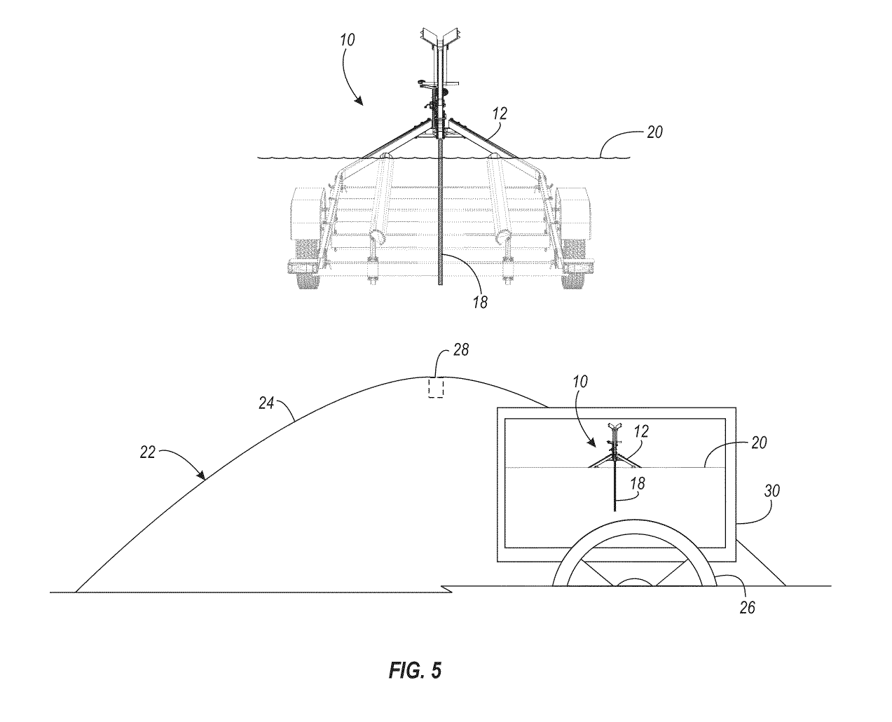

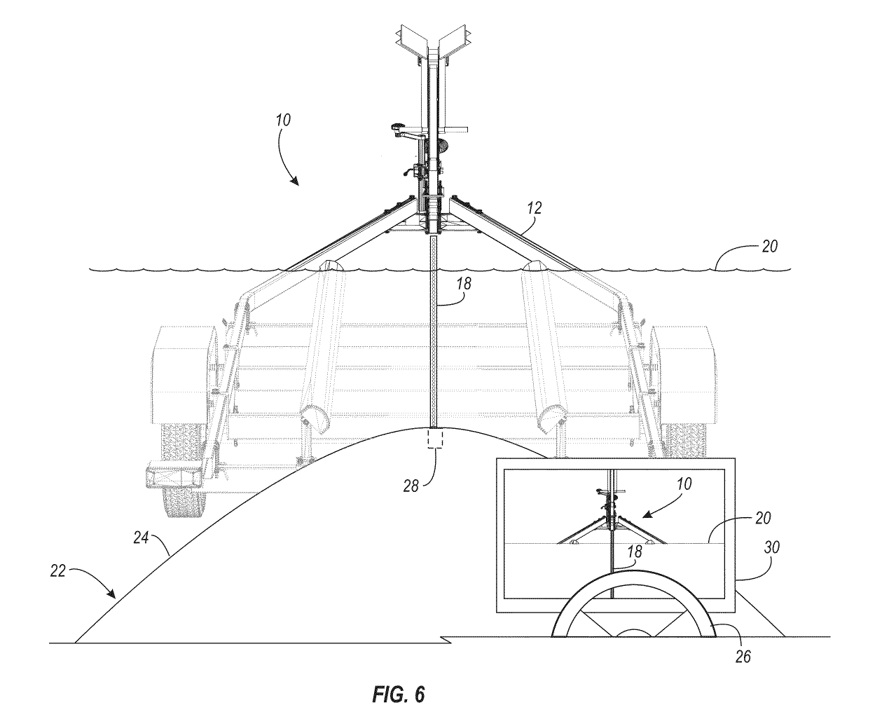

FIGS. 5 and 6 are views of the boat 22 approaching the boat trailer 10 on a boat ramp. As shown in FIG. 5, the boat trailer 10 is backed into the water, and is partially submerged, as illustrated by the water line 20. In FIG. 5, the submerged portion of the boat trailer 10 is shown by dashed lines. During the loading process, the light source is illuminated. Preferably, the light source is bright enough that even the submerged portion can be seen by the boat operator. FIG. 5 also illustrates the output of camera 28 being displayed on display 30. As shown, the boat operator can see the water line 20, boat trailer 10, and the light source 18 on the display 30. In some examples, the camera 28 can have a night vision capabilities (e.g., infrared, etc.) to make the trailer even easier to see in low light conditions. If desired, the light source 18 can configured to optimize the visibility of the emitted light on the display. For example, in the example of a strip of LEDs, the wavelength, intensities, and flashing patterns of the LEDs can be selected for optimum visibility by the camera 28 and display 30 as well as the user.

In the example shown in FIG. 5, the boat 22 is approaching the boat trailer 10. In the example shown in FIG. 6, the boat 22 is getting closer to the boat trailer 10. As with FIG. 5, the display 30 shown in FIG. 6 shows the water line 20, boat trailer 10, and the light source, although the images are larger due to the shorter distance between the boat 22 and the trailer 10.

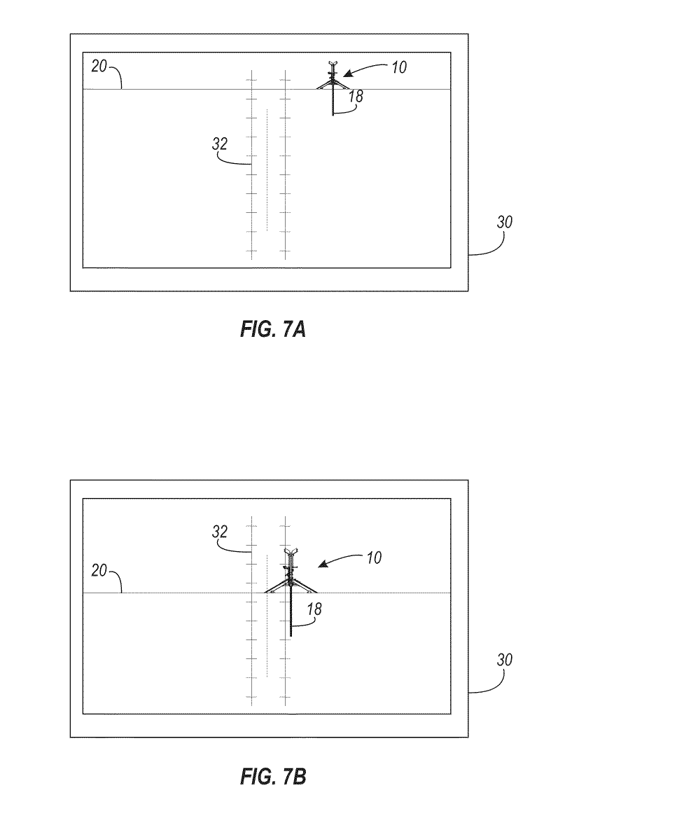

The display 30 may also include any indicators that may assist in guiding the boat 22 to the trailer 10. For example, if the camera is positioned in the center of the boat, as shown in FIGS. 4-6, then the boat 22 should be properly aligned with the trailer 10 when the trailer is centered in the display 30. Of course, in the case of wind or a water current, the boat operator may have to compensate for the wind or current. FIG. 7A shows an example of a display 30 that includes indicator lines 32 on the screen to make it easy to determine when the boat 22 is properly aligned with the trailer 10. In the example shown, a vertical dashed line is shown in the center of the screen, with two vertical lines on each side. The two vertical lines include horizontal markers to help illustrate the relative distance between objects on the screen. In one example, the indicator lines 32 are permanently formed on the display 30. In another example, the indicator lines 32 are generated and displayed on the display 30.

FIGS. 7A-7D show examples of a display when the boat is approaching a boat trailer submerged on a boat ramp. In FIG. 7A, the boat trailer 10 is relatively far away, but is visible, especially the light source 18. Depending on the visibility conditions, the light source 18 may the only thing visible at a relatively long distance. As shown, the display shows the boat trailer 10, the light source 18, and the water line 20. In this example, the boat trailer 10 is positioned to the right of the indicator lines 32, so the boat operator knows that the boat should be steered right as the boat approaches the boat ramp. For the purposes of this example, it is assumed that the operator does not have to compensate for wind or current.

In FIG. 7B, the boat is closer to the boat trailer 10, so the boat trailer 10 appears larger on the display 30. In this example, the boat trailer 10 is still positioned to the right of the indicator lines, so the boat operator knows that the boat should be steered right as the boat continues to approach the boat ramp.

In FIG. 7C, the boat is even closer to the boat trailer 10, so the boat trailer 10 appears larger on the display 30. In this example, the boat trailer 10 is now aligned with the indicator lines, so the boat operator knows that the boat should be steered straight ahead the boat continues to approach the boat ramp. In FIG. 7D, the boat is close to the boat trailer 10 and still aligned, so the boat operator knows that the boat can just be moved straight ahead and loaded in a conventional manner.

The camera output also provides benefits during normal boating operations. For example, before the boat is planning (i.e., the mode of operation of a boat when its weight is predominantly supported by hydrodynamic lift, rather than hydrostatic lift), the bow of the boat may obstruct the view of the boat operator. During this time, the camera may provide the boat operator with views of the obstructed areas. In another example, during low light conditions, the camera may provide a better view of the surroundings, especially if the camera has night vision capabilities. In this example, an IR light source may also be used to further enhance the view.

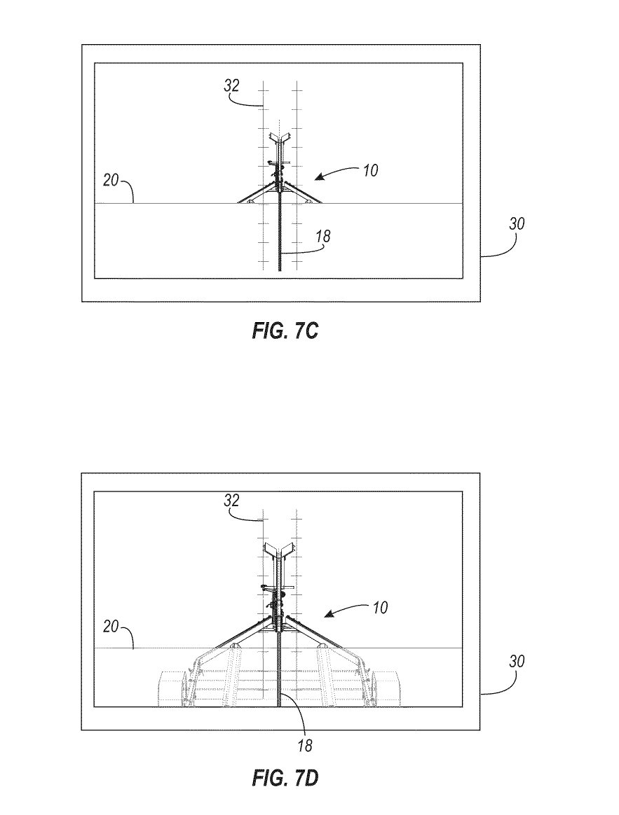

FIGS. 8-11 show examples of other light source configurations. For example, FIG. 8 is a rear isometric view of a boat trailer 10, similar to that shown in FIGS. 1-3, but with an alternative light source configuration. Like the trailer described above, a pair of opposing guide rails 14 are coupled to the frame 12 to guide and support the boat when loaded on the trailer 10. In this example, first and second light sources 18 are also coupled to the trailer 10 and extend generally parallel to the guide rails 14. The light sources 18 may be coupled to the trailer in any desired manner, for example, by being mounted to the frame 12, guide rails 14, or both. The light sources may also be disposed on either side of the guide rails 14, as well as disposed in a recessed guide rail. The light sources 18 shown in FIG. 8 function in a manner similar to the light source shown in FIGS. 1-3. When a boat approaches the trailer 10 of FIG. 8, the boat operator will see two parallel light sources, rather than a single centered light source (FIGS. 1-3).

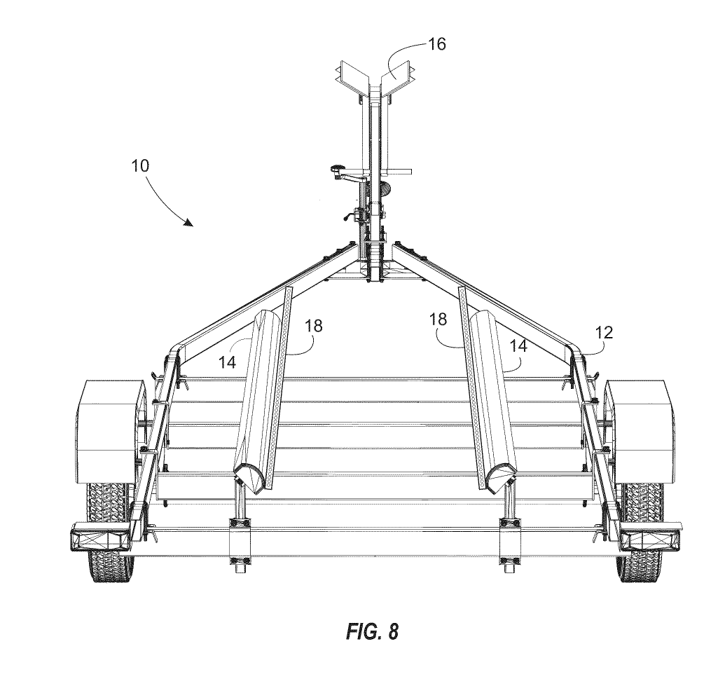

FIG. 9 is a rear isometric view of a boat trailer 10, similar to that shown in FIG. 8, but with another alternative light source configuration. Like in FIG. 8, first and second light sources 18A are coupled to the trailer 10 and extend generally parallel to the guide rails 14. In addition, third and fourth light sources 18B are coupled to the trailer 10 proximate the outside edges of the trailer 10 and extend generally parallel to the first and second light sources 18A. As before, the light sources 18A are coupled to the trailer 10 in any desired manner, for example, by being mounted to the frame 12. The light sources 18A and 18B shown in FIG. 9 function in a manner similar to the light sources described above. When a boat approaches the trailer 10 of FIG. 9, the boat operator will see four parallel light sources. Preferably, the light sources are mounted and positioned in such a way as to not physically interfere with the loading and unloading of a boat on the trailer.

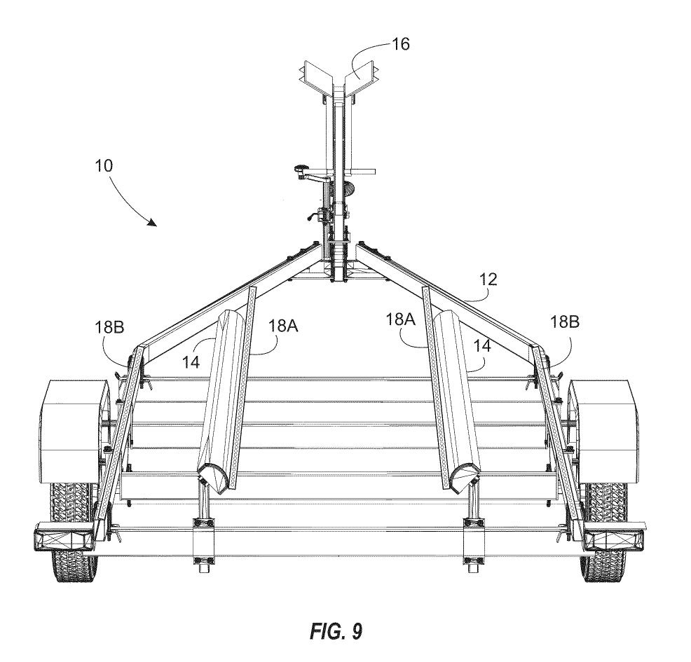

FIG. 10 is a rear isometric view of a boat trailer 10, similar to that shown in FIG. 9, but with another alternative configuration. Like in FIG. 9, first and second light sources 18A and third and fourth light sources 18B are coupled to the trailer 10. In addition, a beacon light(s) 36 is coupled to the trailer 10 proximate the rear end of the trailer 10. In one example, the beacon light 36 is comprised of one or more (three, in the example shown in FIG. 10) relatively bright lights, that will be visible to a boat operator while approaching the trailer 10. In one example, the beacon light 36 comprises bright, focused LED lights, aimed rearward and slightly upward so as to be aimed at the camera (e.g., camera 28 of FIG. 4) of a boat as it approaches the trailer 10 on a boat ramp. With the proper beacon light configuration (e.g., by selecting desired brightness, lenses, etc.), the boat operator will be able to see the beacon light 36, even while the beacon light 36 is submerged in the water, directly and/or via the video display (e.g., display 30 of FIG. 4). The beacon light 36 may be positioned in any desired location on the trailer 10. In addition, multiple beacon lights may also be used, and positioned where desired. When a boat approaches the trailer 10 of FIG. 10, the boat operator will see four parallel light sources (or one, or two, depending on the light source configuration), as well as the beacon light 36. In another example, instead of, or in addition to beacon light 36, one or more reflectors can be mounted on the trailer to reflect light from a boat light source.

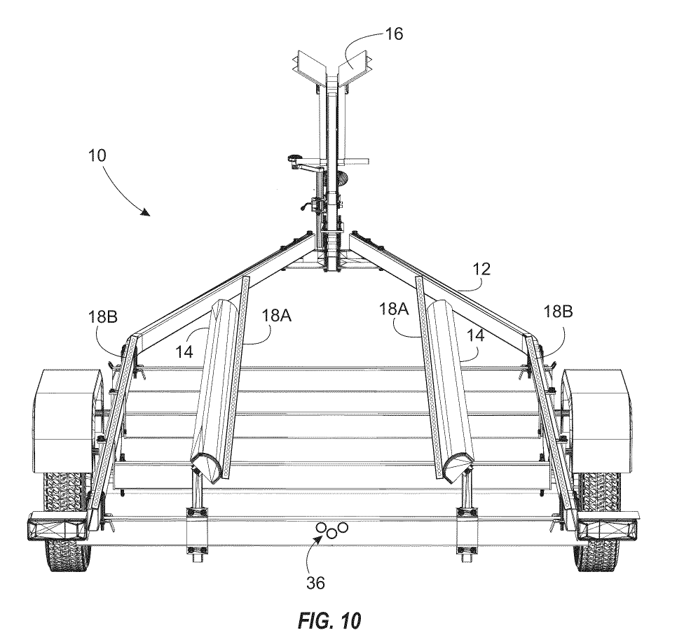

FIG. 11 is a rear isometric view of a boat trailer 10, similar to that shown in FIG. 10, but with another alternative configuration. Like in FIG. 10, first and second light sources 18A and third and fourth light sources 18B are coupled to the trailer 10. In addition, the beacon light 36 is coupled to the trailer 10 proximate the rear end of the trailer 10. In this example, a second beacon light 38 is mounted to the winch post assembly 39 below the winch stand bumpers 16. The beacon light 38 is positioned where it will not be submerged when the trailer 10 is on the boat ramp. The beacon light 38 will help the boat operator identify the proper boat trailer, as well as increase the visibility of the trailer in low visibility conditions. The beacon light 38 can be comprised of any desired type of light including incandescent, LED, etc. The beacon lights 36 and 38 may also be any desired color(s) and can be configured to illuminate constantly, flash, etc., as desired.

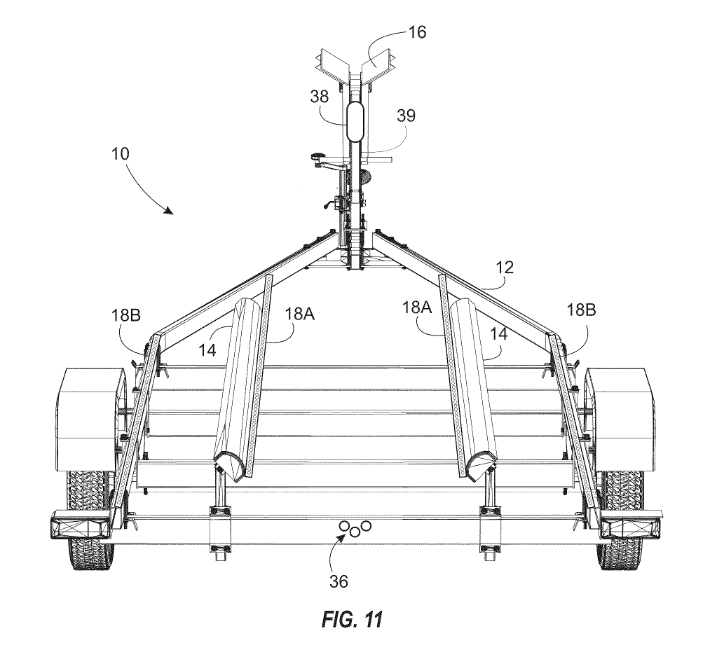

FIG. 12 shows an example of a display when a boat is approaching a boat trailer submerged on a boat ramp. In the example shown in FIG. 12, the boat trailer 10 includes first and second light sources 18 coupled to the trailer 10 and extend generally parallel to the guide rails, like those shown in FIG. 8. The boat trailer 10 also has a beacon light 38 mounted to the winch post assembly below the winch stand bumpers, like that shown in FIG. 11. FIG. 12 shows the display 30 and what is shown on the screen when the boat is relatively close to the boat trailer 10 and aligned, similar to that shown in FIG. 7D. FIG. 12 shows another example of indicator lines 32. In this example, two vertical pairs of indicator lines 32 correspond to the pair of light sources 18 on the boat trailer 10.

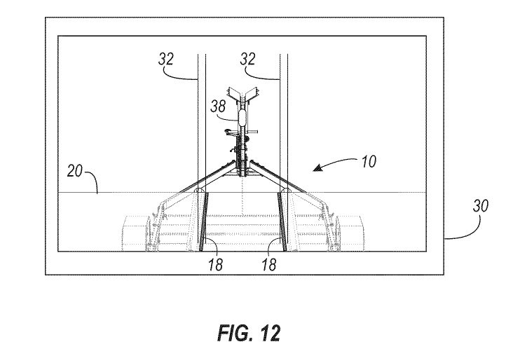

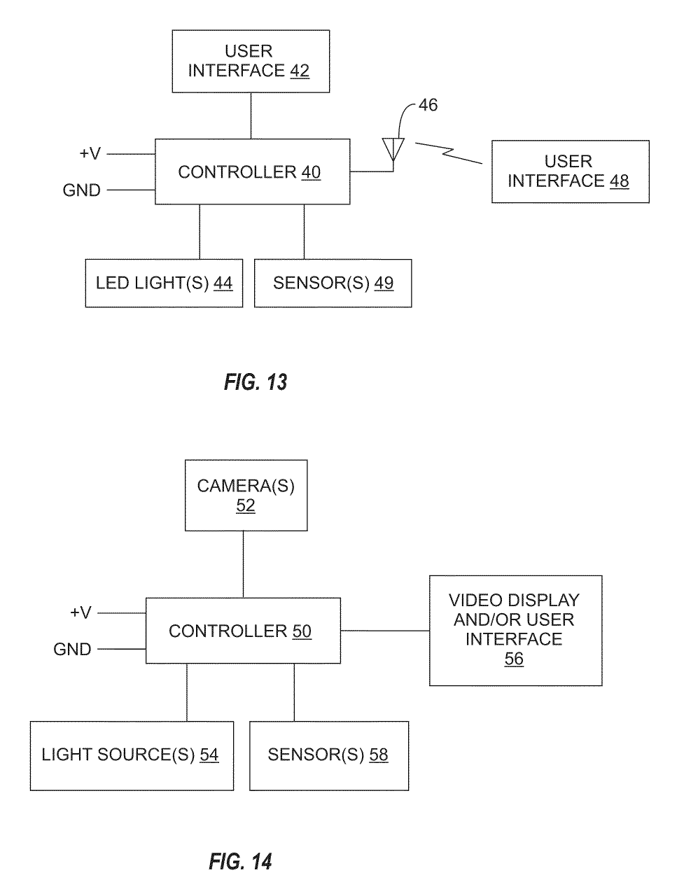

The boat loading system may be designed and configured in any desired manner FIGS. 13-14 are block diagrams of an exemplary boat loading system. FIG. 13 is a block diagram of the portion of a boat loading system associated with a boat trailer. A controller 40 is used to control the boat lighting. In one example, the controller (as well as the other components of the system) is powered by a DC voltage source. The DC voltage source may come from the conventional 12V trailer power, or from an independent source. The system includes a user interface 42, which may be located on the trailer or in the tow vehicle, for example. The user interface could be as simple as an ON/OFF switch, or be more complex, allowing a user to configure the operation of the light sources. One example of a more complex controller, would be one that includes water detection sensor(s) on the trailer. When the trailer backs into the water, the lights could be configured to turn on when the water has reached a certain level on the trailer. This provides the boat driver a more consistent loading onto the trailer. Another ability of the controller that is configured to sense water level, is the fact that the controller could sense multiple water levels and cause the lights to change colors and or flashing patterns or frequencies to help indicate to the user when the ideal trailer depth has been reached in the water. One or more light sources 44 (e.g., LED light strips, beacon lights, etc.) are controlled by the controller 40, at the direction of the user. An antenna (or alternatively, an IR receiver) 46 is used to communicate with optional user interface 48. The user interface 48 may be carried by a user, mounted in the tow vehicle, carried or mounted in the boat, for example. One or more optional sensors 49 are also shown in FIG. 13. The sensor(s) 49 may be wired or wireless. Examples of sensors 49 include, but are not limited to, water sensors, depth sensors, proximity/distance sensors, etc.

FIG. 14 is a block diagram of the portion of a system associated with a boat. A controller 50 is used to control cameras, light sources, user interfaces, etc. In one example, the controller (as well as the other components of the system) is powered by a DC voltage source. The DC voltage source may come from the conventional 12V boat power, or from an independent source. The controller can also control other functions. In the example provided earlier where the camera can be used to provide visibility ahead of the boat before the boat is fully planned, the controller could sense things like boat levelness and acceleration. The controller could then automatically display the camera image on the monitor when the boat is accelerating and is not planed or level. The user may even set the threshold(s) for this. This control example could provide a safer acceleration since the driver can see what is in front of the boat without having to take their hands off of the driving controls to turn on the camera video input to the monitor. Likewise, the controller could automatically turn the camera input OFF when reaching a certain acceleration and/or levelness threshold. The system includes one or more cameras 52, such as camera 28, shown in FIGS. 5 and 6. Additional cameras may provide views in different directions, or from different perspectives. The cameras 52 can be wired to the rest of the system, or may be wireless. The system may also include one or more light sources 54 to illuminate areas around the boat. For example, a light source may be provided near the front of the boat, to illuminate the area that is viewable by the camera. The system also includes a video display and user interface 56. In one example, a touch screen (for example, the display 30 shown in FIGS. 5-7) provides a user interface and a video display. The touch screen may include various menus and controls, allowing a user to configure the system. One or more optional sensors 58 are also shown in FIG. 14. The sensor(s) 58 may be wired or wireless. Examples of sensors 58 include, but are not limited to, level sensors, depth sensors, proximity/distance sensors, accelerometers, etc. In one example, a sensor on the boat is used to determine the distance to the winch post bumpers. This sensor can be used by the boat driver to determine how far away the boat is from the winch post bumpers. In some examples, a user is allowed to configure the display to show the camera output in a full screen, or may use a split screen to also show the output of other systems, such as depth finders, fish finders, boat controls, GPS, sonar, other cameras, etc.

The boat loading system described above can also be configured to interface with a smart phone, tablet, vehicle PC, etc., through any suitable interface, such as Bluetooth. For example, the user interface 48 shown in FIG. 13 may be comprised of a smart phone with an application installed that allows a user to control the light sources 44. Similarly, the user interface 56 shown in FIG. 13 may also include a smart phone with an application installed that allows a user to control the light sources 54 and view the output of the camera 52. If desired, the same smart phone may be used to control the light sources 44 on the boat trailer.

In another example, the system shown in FIG. 14 may include audible indicators that give the boat operator an indication of the distance to the boat trailer. The distance may be determined or calculated using any desired manner of determining the distance, such as an ultrasonic distance sensor, IR distance sensor, laser sensor, GPS, or a signal strength from the trailer, etc.

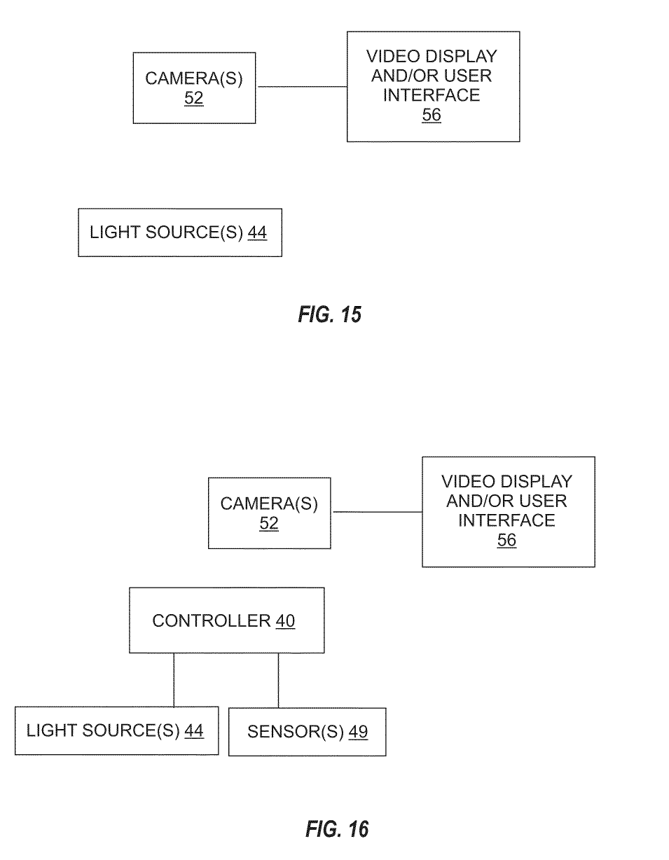

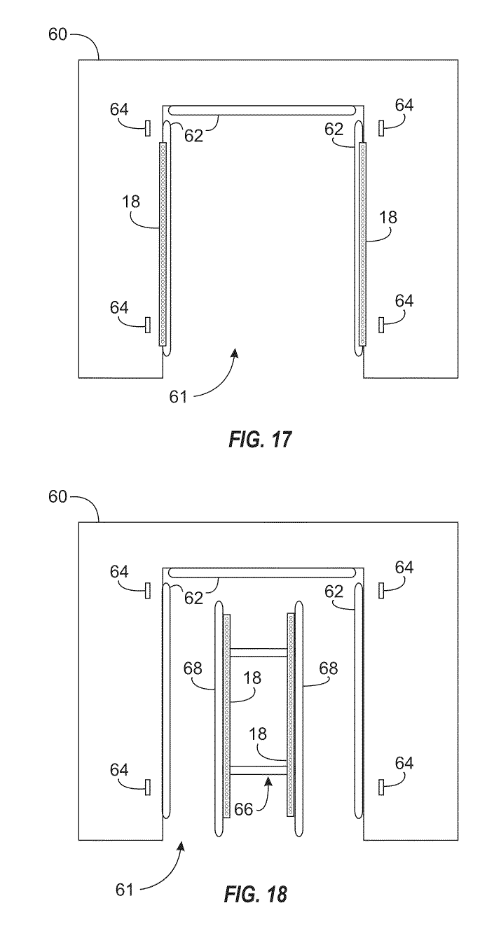

FIGS. 15-16 are block diagrams of additional exemplary boat loading systems. FIG. 15 is a block diagram showing light source(s) 44 that may be mounted at a boat landing site, such as a boat trailer, dock, etc. the light source(s) 44 may be used as described above, although, in this example, light source(s) 44 are de-coupled from the camera and display. The light source(s) 44 may be used alone, without a camera or display.

In that example, a user will use visual self-guidance to the target. The light source(s) 44 may be controlled by a controller, as described above, may be controlled with an ON/OFF switch, or may be configured to turn on with the trailer running lights.

FIG. 16 is a block diagram showing light source(s) 44 and sensor(s) 49 operatively connected to a controller 40. In this example, the light source(s) 44 and sensor(s) 49 can be configured as described above, but may also be de-coupled from the camera 52 and display/user interface 56. In one example, the driver of the trailer tow vehicle may be in control of the light sources 44, rather than the driver of the boat.

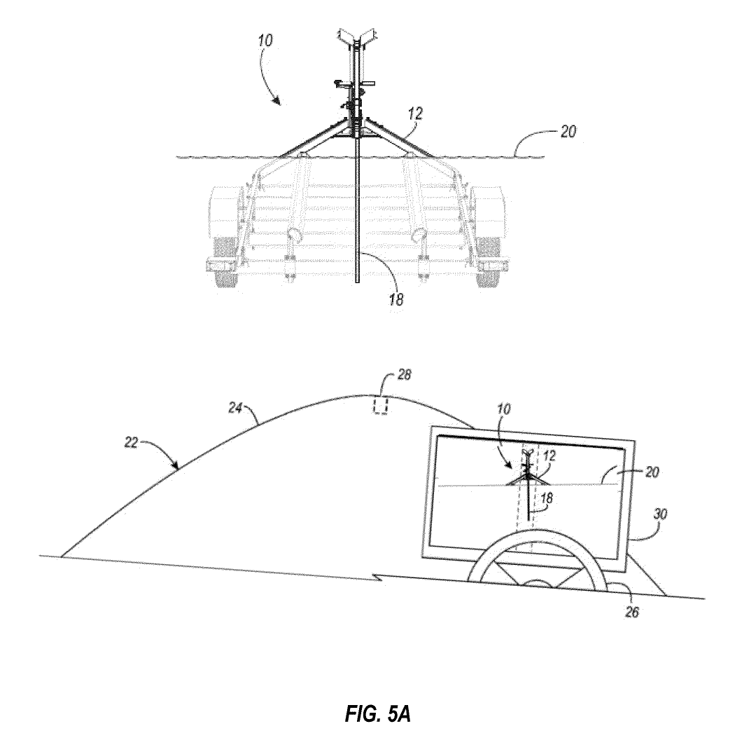

In addition to using the system described above to parking a boat on a boat trailer, the system may also be used when parking a boat at a dock or other desired parking target. FIG. 17 is a top view of a dock 60 having an opening 61 configured to receive a boat. In this example, the dock 60 has three bumpers 52 that protect the hulls of boat from damage from the sides of the dock. In this example, two light sources 18 are attached to the dock 60 and/or bumpers 62 in the proximity of the numbers 62. The boat dock 60 has one or more rope cleats 64 that are used to secure rope(s) that are attached to a boat. The light sources 18 are used in the same manner as the light sources described above that are used with a boat trailer (for example, see FIGS. 8-12).

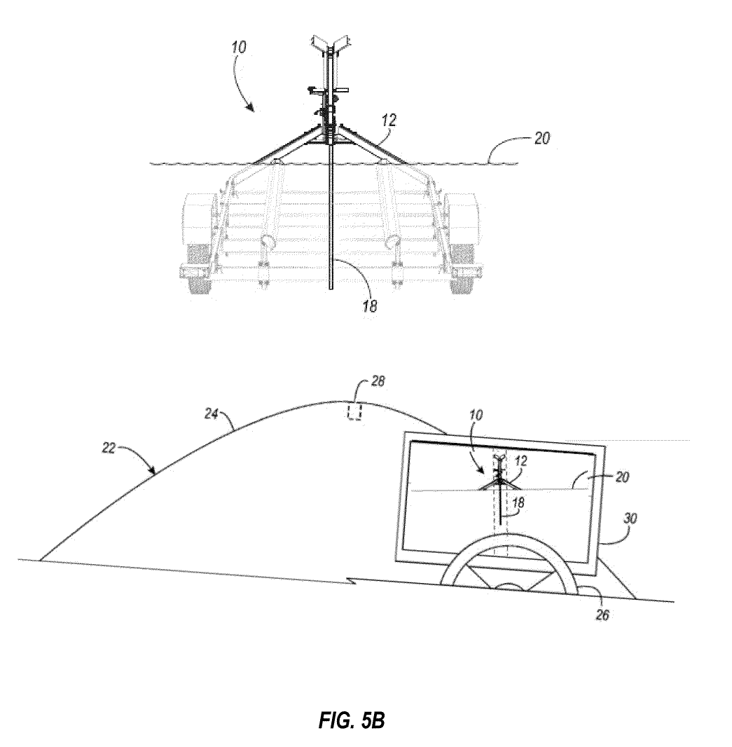

FIG. 18 is a top view of a dock 60, similar to the dock shown in FIG. 17, but includes a boat lift. FIG. 18 shows a partial view of a boat lift 66, which includes a pair of opposing guide rails 68. Before loading a boat on the boat lift, the guide rails 68 are at least partially submerged, allowing the boat to be driven over the boat lift 66. In this example, two light sources 18 are attached to the boat lift 66, roughly in line with the guide rails 68. The light sources 18 may also be attached to the dock (e.g., FIG. 17), or to another part of the lift 66. The light sources 18 are used in the same manner as the light sources described above that are used with a boat trailer (for example, see FIGS. 8-12). As with the example shown in FIG. 9, multiple sets of light sources 18 may also be used. With either example (FIG. 17 or 18), the light sources 16 can be controlled as described above. Since, unlike a boat trailer, there may not be another person at the dock, it may be desired to remotely control the light sources 18 from the boat. Alternatively, the light sources 18 can be configured to turn on automatically, based on the proximity of the boat. In another example, the light sources 18 can be turned on automatically using a dusk/dawn sensor.

As mentioned above, a light source(s) (e.g., light source(s) 44) may be used alone, without a camera or display, enabling a user to use visual self-guidance to a landing target (e.g., boat trailer, dock, etc.). Even without a camera, novel light sources, such as those described above, alone are useful in guiding boats. Historically, it is difficult for boat drivers to approach a trailer and align a boat's center line (from front to rear) with the center line of the trailer (front to rear). However, this alignment is very important in order to achieve a successful loading of one's boat onto a trailer without damaging the trailer or the boat by hitting submerged objects such as the trailer frame, wheel wells, etc. One objective to successfully loading the boat onto the trailer is to cause the boat to approach the trailer in a center-aligned fashion as described above and to make initial contact with the trailer (nose of the boat with rear of the trailer) such that the center of hull of the boat (near the nose) will make contact in between the bunks (guide rails) on the trailer, which are at the center most location on the trailer. Center most location means closest to the center line of the trailer from front to rear of the trailer. Bunks are typically spaced in a mirror image as shown in the figures discussed above (e.g., FIG. 8). Bunks prevent the boat from falling off of the trailer or being off centered or shifting on the trailer during transport. Bunks also bear the weight of the boat while the boat is out of the water, and safely distribute the weight to protect boat and trailer from stresses or out of balance issues that could damage the boat, trailer, or cause the towing vehicle to become erratic during transport due to un-balanced towing loads. These are just some of the reasons why it is important for boat users to properly load a boat onto a trailer, centered and completely in place as designed by the boat and trailer manufacturer.

If the driver of a boat can cause the center front of the hull to make initial contact directly in-between the center two bunkers on the trailer, then the bunkers will help to mechanically align the boat as the driver uses motor power to thrust the boat further towards the front of the trailer. The task of loading a boat onto a trailer in a centered manner as described, such that initial contact is properly between the inner most bunks on the trailer, is many times a challenging task and it is made even more difficult by the fact that the trailer itself is at least partially submerged below the water and the user has limited visibility of the loading features on the trailer, such as the bunks, which are in place on the trailer to properly hold the boat (typically by cradling fashion) into a specific position on the trailer. Aside from the trailer being at least partially submerged, there are many other factors (outlined below) that contribute to making it difficult for the user to approach and load the boat onto the trailer with a centered alignment.

One example of such a factor is low light visibility. It is common for boats (especially fishing boats) to launch early in the morning and to load late in the evening. Both conditions are typically low-light or no-light conditions making it very difficult for the boat driver to see the submerged trailer, wheel wells, and bunkers (for example) as the driver approaches the trailer for loading.

Another example is clarity of water. Each water body has a different level of clarity due to silt, algae, vegetation, or any other debris or matter mixed into the water. The water can be brackish or turbid for example. These conditions can vary significantly based on geographical location or even time of year (seasonal). These conditions can make visibility of the trailer features below the water's surface, very difficult to see and to navigate with the boat when trying to load the boat onto the trailer in a centered fashion.

Another exemplary condition is wind. Wind can cause the surface of the water to be rough which makes it difficult for a user to see below the surface where the trailer loading features are hidden. Another exemplary condition is reflection. As discussed earlier, dark conditions make for poor visibility of the trailer below the water's surface but even in daylight, reflection of lights and clouds on the surface of the water can make it difficult to see below the surface. To make matters even more difficult, it is not uncommon for all of these conditions to be combined at the same time to make it extremely difficult for a boat driver to see the loading features on the trailer when it is at least partially submerged.

The lighting systems discussed above can be used in conjunction with other components discussed above such as camera(s) and/or sensor(s) to make boat loading onto trailer even easier and more convenient but the lights by themselves, without camera(s) and/or sensor(s) or any other control circuitry can still dramatically help a boat driver to overcome the problems described above and achieve a more convenient, more successful, and more consistent loading of their boat onto a boat trailer, point on a dock, or into a boat slip. In order to do so, the challenges of proper loading as well as the factors that create the challenges must be understood first. Then the lights can be implemented in ways to overcome the challenges, making for a very effective guidance system. Following are more details regarding this.

Systems described herein exploit the characteristics of light to overcome all of the conditions (and others) described above so that a user can have a visual target or path in which to align their boat in a centered fashion with the center line of the trailer and to load the boat properly, with greater ease, convenience, and consistency while also reducing the risk of damage to the boat, trailer, and vehicle. The discussion below goes into more detail on how the characteristics of light, lighting source(s), and the physical and electro-mechanical manipulation of the light(s) and lighting source(s) are used to overcome the challenges described above.

First, the use of LED lights has overcome reliability and intensity limitations of other types of lighting such as incandescent lighting. Until recently, lights such as incandescent or halogen (as a couple of examples) were the most available and cost effective lighting sources. However, for the purposes of this example, those types of lights are too prone to broken filaments due to vibration of the lights during transport or sudden changes in temperature as the lights would have gone from heated due to filament power in ambient air to being submerged in much colder water. In addition, these types of lights tend to glow in a broad spectrum of radiance without the use of special lenses to focus the beams. Also, these lights may require filters or caps to change the colors. In doing so, the intensity is greatly reduced. These lighting technologies also suffer from higher power requirements (less efficiency to produce the same amount of light using a given amount of energy). Also, these technologies are bulky in size which would make it very difficult to place them on the trailer in a way that would provide good visibility for the driver while also keeping the lights out of the way of the boat while loading and unloading. In addition, these lights would typically have a glass bulb that would easily be broken during vibration while transporting the trailer, or impact from the boat, or rocks or other road debris that may impact the lights during transport. Furthermore, the reliability issues with these lights would make for difficult replacement in the application of this boat loading system since the lights would need to be installed below the boat where it is difficult for the user to reach when the boat is on the trailer.

With the more recent advances of LED technology, the reliability issues are resolved, making this system more suitable, cost effective, and more maintenance-free. LEDs will not break due to sudden temperature changes. LEDs are easily encapsulated for water-proofing to protect the lights from damage while being submerged in water on the trailer. LEDs are physically smaller and can be installed for use in this system so that they are out of the way of the boat while loading and unloading. This prevents damage to the lighting system as well as the boat. In addition, LEDs are now much more intense, can have varying viewing angles, can be selected with various focus angles so as to provide a distinct spatial viewing angle and intensity, and can be made to emit numerous different colors or wavelengths. In addition, LEDs can also be made to vary the intensity or even flashed in numerous patterns and variations. Some flashing patterns may even be done so fast that it is not detectable to the human eye. This characteristic could allow data to be modulated through the LED(s) emitted light and sent to the boat(s), person, vehicle, etc., where the modulated light can be de-modulated and the data extracted. An example of the data that could be transferred in this manner may be positional feedback to the boat or to the driver such that the driver could be made aware of relative position of the boat relative to the trailer or other features. With such data a user could make adjustments when loading or unloading. This is only one example. There are numerous applications and benefits of transferring data via LED lighting from the trailer to the user or to the boat(s) or vehicle(s). Another example would be that the boat may use the data to automatically position itself onto the trailer. LEDs can be side emitting or emit light at various angles making them more practical for mounting into difficult locations or orientations. This also allows designers to place the lights into more optimal locations such as this system which requires the lights to be placed where the boat cannot impact them, yet the user and/or the guidance system can still benefit from the visibility of the lights. Furthermore, LEDs now have great intensity, ability to be focused, and are much more efficient than other technologies. Efficiency is important as well for this system since the trailer towing vehicle will have a limited amount of practical energy it can deliver to the lights to perform the functions of this system. Since LEDs are of higher efficiency, this means the towing vehicle's available energy can produce more light for the system, resulting in better performance for the user and lower cost to produce and use the system.

Another aspect of how this system utilizes the properties of light to perform the function of the system, is the manipulation of wavelength(s). As mentioned earlier, LEDs can be made to produce many different colors without the loss of intensity which happens when emitting light through colored lenses. In addition, LEDs can be made to produce a single color or narrow band of wavelength. Today's LED dies can also be made with RED, GREEN, and BLUE all on a single LED die. This allows designers to vary the intensity of the red, green, and blue portions of the die in order to make a very wide range of colors or wavelength of light(s). The intensity change control for an individual LED or for a color segment on the die of an LED is usually controlled by either PWM (Pulse Width Modulation) method or by varying the amount of current through the LED or one or more color segments of and LED's die. These methods can be used to control the RED, GREEN, and BLUE light intensity independent of each other, thus creating the net or combined effect of the color or wavelength to be a new color to the human eye. Since RED, GREEN, and BLUE LEDs each have a different turn-on voltage, it is not a good practice to try and change the overall color of an RBG light strip or RGB LED or to change the light output intensity by simply varying the voltage. For example, a BLUE LED requires a higher voltage to forward bias the diode compared to the green and red LED diodes. Therefore, if one were to reduce an RGB LED light string's intensity by reducing the applied voltage to the LED(s), the BLUE LED(s) output would degrade and stop emitting light before the red and the green LED(s) would degrade or stop working, thus the user would lose control over the color and overall intensity. The ability to have control over intensity, focus, viewing angle, and the ability to select or vary the color of light or wavelengths of light are desirable for this system since these characteristics can each be used to make a lighting system that will help overcome the many challenges described earlier on in this description. Another valuable feature of LEDs is the ability to flash them ON and OFF at much higher frequencies or rates compared to other lighting technologies. This allows a designer or user to create lighting flash patterns or sequences that will make the system more visible, recognizable and/or distinct to the user of the boat loading system.

As described earlier, there are many challenges to overcome with the visibility of the trailer features (frame, bunks, wheel-wells, etc. . . . ) when a user is loading a boat onto a trailer. Again, these challenges are made worse by low-light conditions, reflections or glare on the water's surface, and the murkiness or clarity of the water itself. This system can benefit from the manipulation of LED light characteristics to overcome these challenges.

The lighting can be used to simply illuminate the water around the trailer so that the user can see the physical features of the boat such as the bunks so that he/she can guide the boat so that it will load onto the trailer centered with the trailer. The orientation and intensity of the lights in this case, should be such that the trailer features are illuminated or silhouetted by the light source without creating blind spots by the light source itself. In this case, the light beams may need to be pointed at and/or focused onto the target objects such as the inner bunks. But orientation of the lights should not be such that the light beam would temporarily blind the driver by direct line of slight or by reflection. Also in this case, the light wavelength or color can be selected to provide the most visible contrast of the target objects (i.e. bunks) for the user. In other words depending on the clarity of the water or type of debris in the water, one color or wavelength may create a better view and/or better contrasting visibility of the bunker (for example), compared to the surrounding illuminated water.

Another example of such manipulation of the light to provide the illuminated pathway for a boat driver to load his/her boat in a centered fashion with respect to the center line of a trailer is to use a reflective coating or reflective marks or devices applied to the target objects. The reflective material along with the light's wavelength and intensity can be optimized to make the target object more visible and distinct to the user. The reflectors may be chosen to have a higher reflectivity at a specific wavelength or color making the effect to the user be a more pronounced and defined light target. Or another method may be to choose a broad wavelength reflectivity reflector but use a light color source or wavelength range that is absorbed more readily by the matter in the water so as to provide a more clear and distinctive illuminated target due to the user seeing mainly the light that is reflected directly back towards the user versus the light that was absorbed by surrounding matter in the water verses a blurry or hazy glow of light that might occur if the wavelength of the light source were to be reflected readily by the matter in the water. For example, the human eye can see green wavelengths easier than other wavelengths so green may appear more intense or distinctive to the user if green reflective markers are placed on the objects of interest on the trailer such as placing reflective markers along the length of the bunks so that there is a distinct illuminated path for the user to center the boat relative to on the trailer. However, in some water, there may be too much green reflective material or matter in the water which could cause this wavelength range to not be absorbed but rather reflected around in the water, causing the light to glow with a more blurry look instead of creating a crisp and distinctive path. In this case, a different wavelength of light may be more optimal so as to be absorbed by the surrounding matter in the water but yet still be highly reflective by the reflectors, resulting in a more distinct and visible target or path for the user to see.

Another feature of a boat loading system is the use of LED light strips being mounted length wise along the bunks (guide rails) of the trailer as shown in the figures (e.g., FIG. 8). In general, a long path of lights (such as an LED light string or an elongated reflective path) is preferred to make it easier for the driver of the boat to see the path they need to follow in order to keep the boat centered relative to the trailer while loading the boat onto the trailer. The longer illuminated paths also help the user to visualize how aligned the boat is with the respect to the trailer's alignment. Longer illuminated paths helps the driver to see his/her alignment even when pulling forward towards or onto the trailer such that when the front of the boat may be partially blocking his/her visibility to the lights directly below, the driver can still see the portion of lights further towards the front of the trailer which are unblocked by the boat. This helps the user to know if the boat is still in alignment with the trailer or not during the process of loading and unloading on or off the trailer. This is another reason why LED light strings are an advantage since they can be manufactured and easily installed in customized lengths to accommodate a particular boat and trailer design.

Alternatively, in other examples, the LED light strip can be mounted in a single or multiple lines down the center line of the trailer (e.g., FIG. 2). Regardless, one intent is to provide a direct visual path of light that the driver of the boat can see directly without the use of a camera or with the use of a camera. It is important to note that placing lights on a boat trailer for the purpose of providing a visually illuminated path to guide the boat onto the trailer, the illuminated path is more beneficial if the line of light(s) is placed roughly in parallel to the bunks located nearest to the center of the trailer. The center of the trailer is defined as the line from the rear of the trailer to the front trailer hitch tongue with the line being centered equal distance between the left and right side trailer wheels. In other words, the closer the light path is to the center line of the trailer, the better the guide or target is for the driver to aim for when trying to place the boat in the center of the trailer by guiding the center line of the hull of the boat to land on the trailer directly in between the left and right bunks. The lights could be placed further along the outside of the trailer such as near the outside frame members or the wheel wells (e.g., FIG. 9) but this is not as precise a target as would be if the lights were placed along the inner bunks closest to the center line of the trailer. The lights could also be paced in a single line along the center line of the trailer, providing for a single lighted line to guide the driver to the center of the trailer. Furthermore, in any case, the LED light string(s) may be placed such that the lights are physically out of the way of any part of the boat from damaging the lights such as crushing them upon loading or unloading, but the lights need to still be visible at the same time. This is another challenge of the system that has been overcome as described. The bunks can be used to guard against the boat impacting the lights by placing the lights either below the top surface of the bunks (using bracketry or mounting directly to the bunks) so that the hull of the boat cannot reach the lights, or placing the lights along the lower portion of the trailer's frame such that the lights are out of reach and cannot by damaged by the boat. In either example, the placement to avoid damage from the boat may require the LEDs to not face directly upward toward the boat driver. In this case, the intensity and wavelength of the light(s) may be adjusted to overcome any loss of light visibility due to the orientation of the lights. Another solution could be to use side-emitting LEDs such that the light will now be more directly aimed at the driver even though the mounting position of the light may be indirect for a forward emitting LED.

Another aspect of lighting as it relates to this system is color or wavelength effects. For example, the human eye can see green wavelengths easier than other wavelengths so green may appear more intense or distinctive to the user if green reflective markers are placed on the objects of interest on the trailer such placing reflective markers along the length of the bunks so that there is a distinct illuminated path for the user to center the boat relative to on the trailer. However, in some water, there may be too much green reflective material in the water which could cause this wavelength range to not be absorbed but rather reflected around in the water, causing the light to glow with a more blurry look instead of crisp and distinctive path. In this case a different wavelength of light may be more optimal so as to be absorbed by the surrounding matter in the water but yet still be highly reflective by the reflectors, resulting in a more distinct and visible target or path for the user to see.

The example below describes how light wavelength(s) and water clarity can affect the performance of the system based on the type and quantity of matter in the water and the reflective versus absorptive nature (at a given wavelength(s)) of the matter and the reflective target(s). It also describes how these characteristics can be manipulated to design an effective product based on this system. It also teaches that not only can a product be designed by understanding and manipulating these characteristic variables but it also teaches that the system can be designed and implemented in such a way that the user can manipulate these same variables and characteristics in order to create an optimized performance for their specific condition of water, visibility conditions, and application. The examples and descriptions above regarding variables and manipulation of lighting angles and light source orientation as well as wavelength(s) and color(s) of the light are applicable to all methods described for this disclosure.

One method of this system is that the lighting system can be a single color that cannot be changed by the user or it can be a system that allows the user to control the light intensity and/or the color or wavelength of the light or even change the flashing pattern and speed of the pattern for the LEDs. The control can be pre-wired and static (no user control), or it could be wireless or hard-wired such that the user can control the lights via the wired or wireless controls.

For applications where there are many other lights on the trailer or on a boat slip or dock where those lights may compete for the user's attention or where they may make it difficult for the user to discern which lights are to be looked at for alignment and boat loading or guidance purposes, it may be beneficial to set a flashing pattern or contrasting color or combination of the two on the boat guidance system's lights to make it easier for the user to locate and see those lights amongst all the other lights or distractions.

LED light strings can be configured to have some LEDs illuminated as one color while other LEDs in the string can be other colors. This can help the user to gauge how close the boat is to reaching the front end of the trailer where the boat will hit a hard stop. This is particularly useful in low light conditions where it is difficult for the user to gauge how far the boat is loaded onto the trailer. It is a common problem that drivers will thrust the engine too hard thinking they are farther away from the front of the trailer than they really are. This results in a hard ramming of the boat into the front stop of the trailer. By having different colored LEDs arranged in an order such that a specific color represents a certain distance from the front of the boat trailer, the user can visually use the LED colors as a reference with respect to some point or points on the boat to gauge how far away the boat is from being fully loaded onto the trailer.

One unique challenge with this system is that boats have freedom of movements that can cause the camera image to move around on the screen in ways that might make it difficult for the driver to maintain their alignment or know if the boat is truly aligned with the trailer or not.

For example, boats can tilt side to side due to factors such as waves or people moving from one side of the boat to the other, or due to un-even distribution of weight in the boat. This can create a challenge for the guidance system described above. Referring to FIG. 5 (described above), the boat is shown in a level, non-tilted position. If the camera is fixed on the nose of the boat and is mounted such that the camera is level with respect to the water, then the camera image on the monitor will accurately reflect the alignment relationship of the boat's loading approach with respect to the trailer's LED light strip. However, if the same is true except the boat is tilted slightly to one side (as if a person leans over the side of the boat and cause the boat to tilt), this causes the camera to tilt along with the boat in such a way that the camera image will be displayed slightly rotated on the monitor. FIG. 5A shows an example similar to FIG. 5, but with the boat 22 tilted slightly to the right. As shown on the display 30, the image of the frame 12 of the trailer is displayed rotated or tilted, relative to the display 30. The amount of rotation will be proportional to the amount of tilt the boat has.

When the image is rotated on the monitor, then appearance of the trailer LED strip line(s) 18 will also be rotated on the screen, which could give the appearance to the boat driver that the boat is not in a straight alignment with the trailer, when the boat and trailer are actually aligned. This is especially true when using graphical alignment/guidance lines added to the monitor's screen (as illustrated by the dashed lines in on the display 30 of FIG. 5A) to help the user align those lines to the LED light strip on the screen or other references from the boat trailer or boat slips that appear on the monitor screen as described within this disclosure. For example, consider the application where the boat trailer has a single LED light strip down the center of the trailer. Let's assume the boat is perfectly centered and aligned with the trailer while the driver is approaching the trailer for loading. In this case, if the boat is level (side to side) the LED line should appear on the screen as a vertical line centered on the screen (e.g., FIG. 5). If the boat is tilted (side to side) for some reason, then the camera will be rotated as a result and the camera image will also be rotated on the monitor, causing the trailer LED strip to appear as a vertical line on the monitor but it will be angled (not perfectly vertical) (FIG. 5A). At the same time, the graphical lines which are programmed to be on the monitor will remain fixed in their perfectly vertical positions relative to the monitor's edges. As you can see, the LED strip and the graphical guidance lines will not be parallel to each other and this may cause the driver to assume the boat is not perfectly aligned with the trailer.

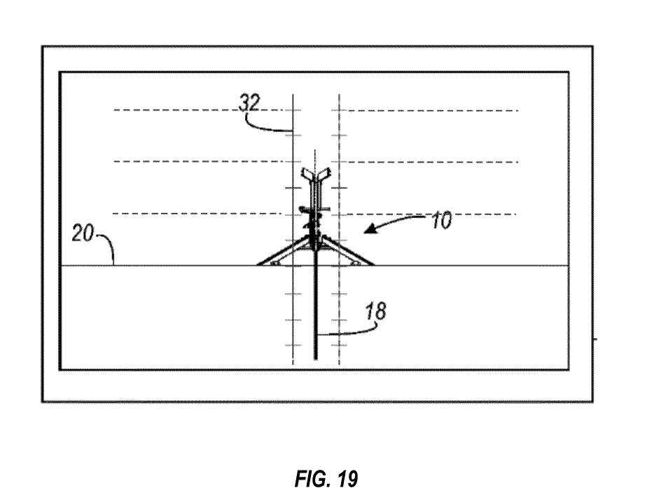

There are a few novel ways to address this scenario. One way is for the user or driver to ensure the boat is not tilted (side to side) while using the system. In this scenario, it may aid the user to know if the boat is level by overlaying horizontal graphical lines on the monitor so that the user can compare those lines to level references in the camera image such as the water's edge. FIG. 19 is an example of a display with overlaid horizontal graphical lines (the dashed lines) on the monitor. The user/driver can adjust the weight distribution in the boat until the horizontal graphical line(s) are parallel to know level references such as the water line described above. In addition, text could be added to the monitor's screen to remind the driver/user to maintain the boat's levelness to ensure accuracy of the system.

Another way is to mount the camera such that it is always level (side to side) even if the boat tilts (side to side). This can be done by mounting the camera on an axis that is free to move allowing the camera to rotate side to side as the boat tilts side to side, in such a way that the camera will remain level with respect to the water even when the boat is tilted with respect to the water. A weighted ballast could be used to provide the necessary counter balance that would cause the camera to stay level.

Another way to keep the camera level (side to side) when the boat is not level (side to side) is to mount the camera on a motorized mount. The motorized mount could receive inclinometer feedback from an inclinometer or tilt sensing device or circuitry used to measure the amount of side to side tilt of the boat. The motorized mount could use this tilt data to adjust the camera's rotational position so as to maintain the camera in a level position (with respect to water) at all times.

Another solution is to use an inclinometer sensor (e.g., one or more of sensors 58 shown in FIG. 14) and/or circuitry to measure the boat's side to side tilt. This tilt data feedback from an inclinometer or tilt sensing device or circuitry can be used to change the angle of the overlaid graphical vertical bars on the monitor. FIG. 5B shows an example of a display 30 having overlaid graphical vertical bars that change based on inclinometer data. as shown, the vertical bars (the dashed lines) change with the tilt of the boat. The angle of the reference/guidance bars on the monitor can be changed in correlation to the amount of tilt of the boat in such a way that it would compensate of for the camera image being rotated on the screen. For example, if the boat tilt causes the trailer's LED strip line to appear on the screen rotated by 5 degrees more than it would be if the boat was perfectly level, then the control circuitry and/or software and/or firmware that controls the vertical graphical lines on the screen could be implemented in such a way as to adjust the graphical lines on the monitor to the same amount of angle that the trailer LED strip was rotated (e.g., as shown by the dashed lines in FIG. 5B). This could all be done by controls circuitry and/or software and/or firmware reading the inclinometer sensor data and making the correct amount of graphical angular adjustment based on the amount of boat tilt. With this implementation, the boat could tilt side to side due to waves, un-even weight distribution or any other reason and the vertical reference lines on the screen would always maintain proper angular and or parallelism and correlation to the LED strip line on the trailer, as seen on the video monitor screen. With this implementation and example, the driver only needs to keep the trailer LED line oriented in the center and parallel to the vertical graphical guidance lines on the screen with little concern about keeping the boat level.

Another solution would be to use the same inclinometer feedback as described above but instead of changing the graphical lines in correlation to the boat tilt, the camera image itself could be adjusted in correlation to the boat's tilt. For example, the camera image could be rotated on the display such that it offsets the amount of rotation that would have otherwise (without any adjustments) appeared on the screen due to boat and camera tilt. This would cause the image on the monitor to always appear on the screen as if the boat were level and not experiencing any tilt.

In the preceding detailed description, the disclosure is described with reference to specific exemplary embodiments thereof. Various modifications and changes may be made thereto without departing from the broader spirit and scope of the disclosure as set forth in the claims. The specification and drawings are, accordingly, to be regarded in an illustrative rather than a restrictive sense.

What is claimed is:

1. A boat loading system comprising:
a light source coupled to a boat trailer;
a camera coupled to a boat;
a video screen operatively coupled to the camera for displaying video from the camera; and
wherein the video screen and camera are configured to convey the relative position of the light source and the boat to assist a boat operator in guiding the boat to a desired position relative to the boat trailer.

2. The boat loading system of claim 1, wherein the light source comprises an LED light strip.

3. The boat loading system of claim 2, further comprising a second LED light strip.

4. The boat loading system of claim 2, wherein the operation of the LED light strip is programmable.

5. The boat loading system of claim 1, wherein the light source comprises an elongated light source positioned proximate the center of the boat trailer.

6. The boat loading system of claim 1, wherein the light source comprises first and second elongated light sources positioned relatively parallel to one another on the boat trailer.

7. The boat loading system of claim 1, wherein the camera has night vision capabilities.

8. The boat loading system of claim 7, wherein the light source includes one or more infrared sources.

9. The boat loading system of claim 1, wherein the video screen displays one or more visual indicators, and wherein the visual indicators relate to a desired position of the light source on the video screen.

10. A boat loading system comprising:
a light source configured to be installed on a boat trailer;
a camera configured to be installed on a boat;
a video screen configured to be installed on the boat and to be operatively coupled to the camera for displaying video from the camera; and
wherein the video screen and camera are configured, when installed, to convey the relative position of the light source and the boat to assist a boat operator in guiding the boat to a desired position relative to the boat trailer when loading the boat on the boat trailer.

11. The boat loading system of claim 10, wherein the light source comprises an LED light strip.

12. The boat loading system of claim 11, wherein the light source comprises a second LED light strip.

13. The boat loading system of claim 11, further comprising an LED controller for controlling the operation of the LED light strip.

14. The boat loading system of claim 13, wherein the LED controller is configured to allow a user to control the intensity and color of the LED light strip.

15. The boat loading system of claim 13, wherein the LED controller includes a wireless interface.

16. The boat loading system of claim 10, wherein the video screen is configured to show one or more visual indicators, and wherein the visual indicators relate to a desired position of the light source on the video screen.

17. A method of parking a boat at a desired parking target comprising:
activating a light source on the parking target;
guiding the boat toward the parking target based on the relative positions of the light source and the boat.

18. The method of claim 17, wherein the light source comprises an LED light strip.

19. The method of claim 18, wherein the parking target is a boat trailer.

20. The method of claim 17, wherein the parking target is a dock.
